(19) United States
(12) Patent Application Publication
(10) Pub. No.: US 2013/0004872 A1
(43) Pub. Date: Jan. 3, 2013

(54) METHOD FOR EARLY DETECTION OF MEMBRANE FAILURES OF FUEL CELL STACKS AND FUEL CELL SYSTEM COMPONENT DEFECTS

(75) Inventors: Brian McMurrough, Honeoye Falls, NY (US); Bernd Krause, Liederbach (DE)

(73) Assignee: GM GLOBAL TECHNOLOGY OPERATIONS LLC, DETROIT, MI (US)

(21) Appl. No.: 13/175,007

(22) Filed: Jul. 1, 2011

(51) Int. Cl. H01M 8/04

(52) U.S. Cl. 429/432

(57) ABSTRACT

A system and method for determining a possible failure of membranes in the fuel cells for a fuel cell stack. The method includes monitoring the stack current density and the minimum cell voltage of the fuel cells in the stack. If both the minimum cell voltage and the stack current density are below predetermined values, then the method multiplies scaling factors of the minimum cell voltage and the stack current density to provide a membrane failure factor. If the membrane failure factor is greater than a threshold, then an indication is given of a possible membrane failure.

### BACKGROUND OF THE INVENTION

1. Field of the Invention

This invention relates generally to a system and method for detecting a possible failure of membranes for fuel cells in a fuel cell stack and, more particularly, to a system and method for detecting a possible failure of membranes for fuel cells in a fuel cell stack that includes determining whether a multiplication factor determined from a minimum cell voltage and a stack current density is greater than a predetermined multiplication factor that indicates a possible failure.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs can be made by other techniques, such as catalyst coated diffusion medium (CCDM) and physical vapor deposition (PVD) processes. MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

As a fuel cell stack ages, the performance of the individual cells in the stack degrade differently as a result of various factors. There are different causes of low performing cells, such as cell flooding, loss of catalyst, etc., some temporary and some permanent, some requiring maintenance, and some requiring stack or fuel cell replacement to replace low performing cells. Although the fuel cells are electrically coupled in series, the voltage of each cell when a load is coupled across the stack decreases differently, where those cells that are low performing cells have lower voltages. Thus, it is necessary to monitor the cell voltages of the fuel cells in the stack to ensure that the voltages of the cells do not drop below a predetermined threshold voltage to prevent cell voltage polarity reversal, possibly causing permanent damage to the cell.

One type of fuel cell degradation is cell membrane failure, which causes cell voltage loss particularly at low stack current densities. Membrane failure is typically the result of many factors. For example, ineffective separation of the fuel and the oxidant could lead to accelerated failure of the membranes and the MEAs. Also, membrane failure can occur from mechanical stress that is induced on the membrane by the dynamic operation and dynamic change in operating conditions, especially as a result of the constant change of temperature and humidity. Another factor that can cause membrane failure is the chemical stress that can occur in the operating fuel cell. Membrane failure could also be the result of other factors, such as mechanical or fatigue failures, shorting, etc.

Cell membrane failure will typically cause one or both of two phenomenons. One of those phenomena includes reactant gas cross-over through the membrane in a fuel cell that occurs as a result of pin-holes and membrane thinning that causes a voltage loss of the fuel cell. Pin-holes occur over time in response to the electrical environment within the fuel cell as a result of its operation. Reactant gas cross-over can occur from cathode to anode or anode to cathode depending on the relative pressures and partial pressures therebetween, which have the same failure consequences. As the size of the pin-holes increases and the amount of gas that crosses through the membrane increases, cell failure will eventually occur. Further, at high loads where significant power is being drawn from the fuel cell stack, a low performing cell that occurs as a result of cross-over could result in a stack quick-stop.

Another phenomenon of cell membrane failure occurs because of cell shorting, where the cathode and anode electrodes become in direct electrical contact with each other as a result of some undesirable condition.

Other types of fuel cell degradation are generally referred to as electrode failures, which also cause cell voltage loss and typically occur over all stack current densities or at least at high stack current densities. Fuel cell electrode failures are typically the result of flow channel flooding and general cell degradation, catalyst activity loss, catalyst support corrosion, electrode porosity loss, etc., over time.

U.S. application Ser. No. 12/690,672, titled Detection Method for Membrane Electrode Failures and Fuel Cell Stacks, filed Jan. 20, 2010, assigned to the assignee of this application and herein incorporated by reference, discloses a system and method for detecting failure of a membrane in a fuel cell for a fuel cell stack that includes calculating an absolute delta voltage value that is an average of the difference between an average cell voltage and minimum cell voltage at multiple sample points.

As discussed above, it has been shown that as a fuel cell stack ages as it nears its end of life, many of the fuel cell membranes in the stack become relatively thin and allow increased cross-over through the membrane, which has the undesirable effects referred to above. Because a large portion of the membranes do become thin, the average cell voltage is reduced, and the relative difference between the average cell voltage and the minimum cell voltage may not indicate that there is a membrane thinning and cross-over problem. Further, it has been shown that at high stack current densities, where the anode and cathode flow rates are high, anode and cathode stochiometries typically overcome the problem of cross-over, where it may not be detectable.

It has been shown that stack cross-over problems become more prevalent at low stack current densities where the flow rates are low and the cross-over effect is not masked. Further, stack cross-over becomes more pronounced when the amount of hydrogen and oxygen being supplied to the cathode and anode sides of the stack is tightly controlled to ensure proper emissions and stack operation, where any reduction of those gases as a result of cross-over may have significant and undesirable effects on stack stability.

### SUMMARY OF THE INVENTION

In accordance with the teachings of the present invention, a system and method are disclosed for determining a possible failure of membranes in the fuel cells for a fuel cell stack. The method includes monitoring the stack current density and the minimum cell voltage of the fuel cells in the stack. If both the minimum cell voltage and the stack current density are below predetermined values, then the method multiplies scaling factors of the minimum cell voltage and the stack current density to provide a membrane failure factor. If the membrane failure factor is greater than a threshold, then an indication is given of a possible membrane failure.

Additional features of the present invention will become apparent from the following description and appended claims, taken in conjunction with the accompanying drawings.

### BRIEF DESCRIPTION OF THE DRAWINGS

FIG. 1 is a simplified block diagram of a fuel cell system;

FIG. 2 is a graph with stack current density on the horizontal axis and minimum cell voltage on the vertical axis showing a relationship for determining stack membrane failure; and

FIG. 3 is a flow chart diagram showing a process for determining stack membrane failure.

### DETAILED DESCRIPTION OF THE EMBODIMENTS

The following discussion of the embodiments of the invention directed to a system and method for detecting possible failure of membranes in fuel cells for a fuel cell stack based on a multiplication factor between a minimum cell voltage and stack current density is merely exemplary in nature, and is in no way intended to limit the invention or its applications or uses.

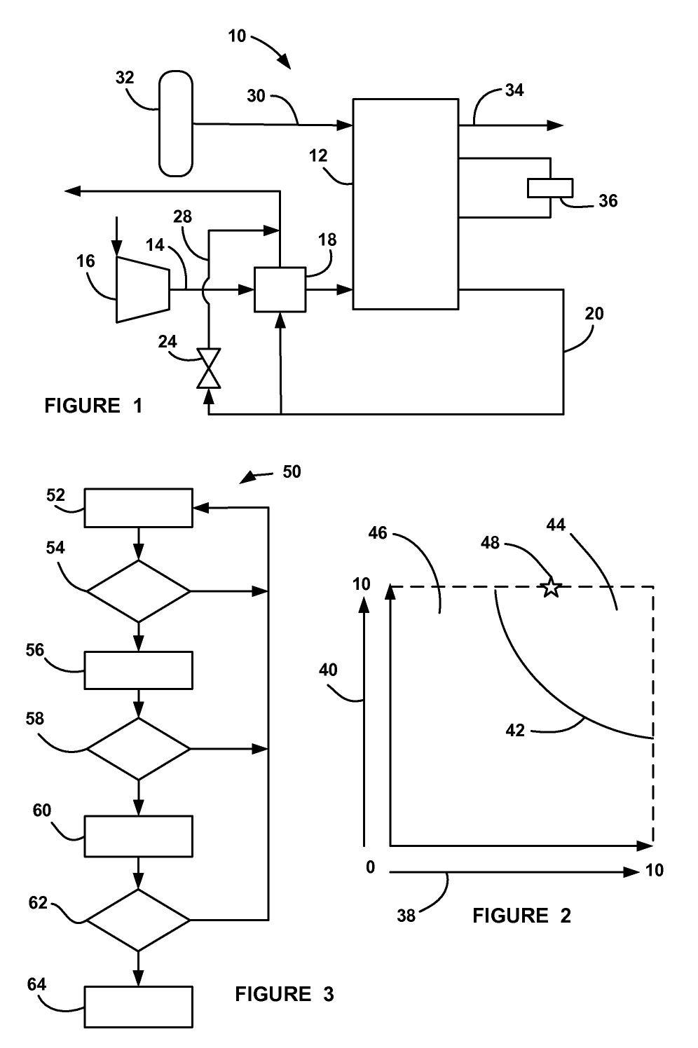

FIG. 1 is a schematic block diagram of a fuel cell system 10 including a fuel cell stack 12. A compressor 16 provides an air flow to the cathode side of the fuel cell stack 12 on a cathode input line 14 through a water vapor transfer (WVT) unit 18 that humidifies the cathode input air. A cathode exhaust gas is output from the stack 12 on a cathode exhaust gas line 20. The cathode exhaust gas line 20 directs the cathode exhaust gas to the WVT unit 18 to provide water vapor to humidify the cathode input air. A by-pass line 28 is provided around the WVT unit 18 and a by-pass valve 24 is provided in the by-pass line 28 and is controlled to selectively redirect the cathode exhaust gas through or around the WVT unit 18 to provide the desired amount of humidity to the cathode input air. The fuel cell stack 12 receives hydrogen gas from a hydrogen source 32 on an anode input line 30 to the anode side of the stack 12 and provides an anode exhaust gas on line 34. A voltage and current monitoring circuit 36 is electrically coupled to the fuel cells that measures and monitors the voltage of each of the fuel cells in the stack 12 and measures stack current density.

The present invention proposes a method for determining that significant cross-over is occurring through the membranes of fuel cells in the fuel cell stack 12 and that the stack 12 is near its end of life. The effects of nitrogen cross-over are more prevalent at low stack current densities, where the cathode and anode flows through the stack 12 are significantly reduced. For example, if a vehicle is at idle, such as at a stop light, for a certain period of time, where the stack current density would be low, and then the vehicle operator presses the throttle once the light has changed, where the stack current density goes up quickly, a stack with fuel cells having significant nitrogen cross-over may cause stack instability to occur. Therefore, the present invention looks at determining membrane failure at only low stack current densities. Particularly, the method of the present invention identifies a multiplication factor that is determined by multiplying a scaled minimum cell voltage factor and a scaled current density factor when both the minimum cell voltage and the stack current density are below predetermined values, and then compares the multiplication factor to a threshold.

FIG. 2 is a graph with a scaled stack current density (A/cm²) on the horizontal axis and a scaled minimum cell voltage (mV) on the vertical axis showing a graphical representation of the technique for determining a multiplication factor for determining fuel cell membrane cross-over. In this example, the algorithm only determines the multiplication factor when the stack current density is below a predetermined stack current density, such as 0.667 A/cm², which is given a scale factor of zero, at the left end of line 38. The stack current density is scaled along the line 38 to a scale factor of 10 at 0.0 A/cm₂ at a right end of the line 38. Likewise, the algorithm only determines the multiplication factor if the minimum cell voltage is below a predetermined cell voltage, such as 667 mV, which is given a scale factor of zero at the bottom end of line 40. The cell voltage is scaled along the line 40 to a scale factor of 10 at 0 mV at a top end of the line 40.

Through experimentation, or other processes, the multiplication factor is determined so that it identifies a threshold above which the multiplication factor indicates that one or more of the cells is exhibiting significant nitrogen cross-over. For the example being discussed, that multiplication factor is 30, which is represented by line 42 and defines a cross-over region 44 and a no-cross-over region 46. For example, if the minimum cell voltage is 0 mV and the stack current density is 0.333 A/cm², the minimum cell voltage scale factor is 10 and the current density scale factor is 5, which gives a multiplication factor of 50 at point 48. The multiplication factor 50 is greater than the threshold multiplication factor 30 so it is in the cross-over region 44, indicating that there is significant cross-over.

If both the minimum cell voltage and the stack current density both fall below the minimum values during a drive cycle, and the multiplication factor is generated, that factor is stored in a memory. As the drive cycle continues, the algorithm monitors the multiplication factor being calculated, and if a new calculated multiplication factor is greater than the stored multiplication factor, then the algorithm replaces the stored multiplication factor with the new larger multiplication factor so that the highest multiplication factor that occurs during that cycle is stored. Otherwise, the algorithm discards the lesser multiplication factors. The system can give a warning of a potential cell failure based on the multiplication factor using any suitable analysis of the stored multiplication factors for each drive cycle. For example, the system can indicate a potential cell failure if a multiplication factor above 30 is stored for a certain number of consecutive drive cycles.

FIG. 3 is a flow chart diagram 50 showing a process for detecting possible failure of membranes in the fuel cells for the fuel cell stack 12 in the manner as discussed above. During a drive cycle, or while the fuel cell system is operating, the algorithm scans for a maximum deviation, which is the multiplication factor referred to above, at box 52. At decision diamond 54, the algorithm determines whether the minimum cell voltage and the stack current density are both below the predetermined values at the same time, as discussed above, and if not, returns to the box 52 to continue to scan for the maximum deviation. If both the minimum cell voltage and the stack current density are below the minimum values at the decision diamond 54, then the algorithm converts both of the values to the scaling factors and multiplies them together to get the deviation at box 56. The algorithm then compares the calculated deviation with a threshold multiplication factor at decision diamond 58, and if it less than the threshold multiplication factor the algorithm returns to the box 52 to continue to scan for the deviation. If the calculated multiplication factor is greater than the threshold multiplication factor at the decision diamond 58, then the algorithm increments a counter at box 60, and stores the multiplication factor. The algorithm then determines whether the counter is above a predetermined count at decision diamond 62, and if not, returns to the box 52 to continue the scan because the deviation has not occurred frequently enough. If the count does exceed the threshold at decision diamond 62, meaning that multiple occurrences of the minimum deviation have been exceeded, then the algorithm sets a diagnostic trouble code for membrane failure at box 64.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for detecting a possible membrane failure in fuel cells for a fuel cell stack, said method comprising:
monitoring voltages of the fuel cells in the fuel cell stack;
identifying a minimum cell voltage from the cell voltages of the fuel cells in the fuel cell stack;
determining a current density of the fuel cell stack;
calculating a multiplication factor from a multiplication of representative values of the minimum cell voltage and the stack current density; and
comparing the multiplication factor to a threshold multiplication factor to determine whether the possible membrane failure is occurring.

2. The method according to claim 1 further comprising scaling the minimum cell voltage and the stack current density between zero and a predetermined number to provide the representative values, where zero represents a minimum cell voltage and a minimum current density and the predetermined number represents zero cell voltage and zero stack current density.

3. The method according to claim 2 wherein the predetermined number is 10.

4. The method according to claim 3 wherein the threshold multiplication factor is 30.

5. The method according to claim 1 wherein calculating the multiplication factor includes calculating the multiplication factor only if the minimum cell voltage is less than a predetermined minimum cell voltage and the stack current density is less than a predetermined minimum stack current density.

6. The method according to claim 5 wherein the predetermined minimum cell voltage is 667 mV and the predetermined minimum stack current density is 0.667 A/cm².

7. The method according to claim 1 further comprising determining that membrane failure is occurring if the multiplication factor is greater than the threshold multiplication factor for more than a plurality of a predetermined number of times that the multiplication factor is calculated.

8. The method according to claim 1 further comprising storing a maximum multiplication factor from all of the calculated multiplication factors over a certain time period.

9. A method for detecting possible membrane failure in fuel cells for a fuel cell stack, said method comprising:
monitoring voltages of the fuel cells in the fuel cell stack;
identifying a minimum cell voltage from the cell voltages of the fuel cells in the fuel cell stack;
determining whether the minimum cell voltage is less than a predetermined minimum cell voltage;
determining a current density of the fuel cell stack;
determining whether the stack current density is less than a predetermined minimum stack current density;
scaling the minimum cell voltage between 0 and 10 to provide a minimum cell voltage scale factor if the minimum cell voltage is less than the predetermined minimum cell voltage, where zero represents the predetermined minimum cell voltage and 10 represents zero cell voltage;
scaling the stack current density between 0 and 10 if the stack current density is less than the predetermined minimum stack current density, where zero represents the predetermined minimum stack current density and 10 represents zero stack current density;
calculating a multiplication factor that is the minimum cell voltage scale factor times the minimum stack current density scale factor;
comparing the multiplication factor to a threshold multiplication factor; and
determining that membrane failure may be occurring if the multiplication factor is greater than the multiplication factor threshold.

10. The method according to claim 9 wherein the threshold multiplication factor is 30.

11. The method according to claim 9 wherein the predetermined minimum cell voltage is 667 mV and the predetermined minimum stack current density is 0.667 A/cm².

12. The method according to claim 9 further comprising determining that membrane failure is occurring if the multiplication factor is greater than the threshold multiplication factor for more than a plurality of predetermined number of times that the multiplication factor is calculated.

13. The method according to claim 9 further comprising storing a maximum multiplication factor from all of the calculated multiplication factors over a certain time period.

14. A system for detecting a possible membrane failure in fuel cells for a fuel cell stack, said system comprising:
means for monitoring voltages of the fuel cells in the fuel cell stack;
means for identifying a minimum cell voltage from the cell voltages of the fuel cells in the fuel cell stack;
means for determining a stack current density of the fuel cell stack;
means for calculating a multiplication factor from a multiplication of representative values of the minimum cell voltage and the stack current density;
means for comparing the multiplication factor to a threshold multiplication factor to determine whether the possible membrane failure is occurring; and
means for determining that membrane failure is occurring if the multiplication factor is greater than the threshold multiplication factor for more than a plurality of predetermined number of times that the multiplication factor is calculated.

15. The system according to claim 14 further comprising means for scaling the minimum cell voltage and the stack current density between zero and a predetermined number to provide the representative values, where zero represents a minimum cell voltage and a minimum current density and the predetermined number represents zero cell voltage and zero stack current density.

16. The system according to claim 14 wherein the means for calculating the multiplication factor calculates the multiplication factor only if the minimum cell voltage is less than a predetermined minimum cell voltage and the stack current density is less than a predetermined minimum stack current density.

17. The system according to claim 16 wherein the predetermined minimum cell voltage is 667 mV and the predetermined minimum stack current density is 0.667 A/cm².

18. The system according to claim 14 further comprising means for determining that membrane failure is occurring if the multiplication factor is greater than the threshold multiplication factor for more than a plurality of a predetermined number of times that the multiplication factor is calculated.

19. The system according to claim 14 further comprising means for storing a maximum multiplication factor from all of the calculated multiplication factors over a certain time period.
